(19) United States
(12) Patent Application Publication
(10) Pub. No.: US 2025/0224918 A1
(43) Pub. Date: Jul. 10, 2025

(54) Immersive Contextual Audio Effects In E-Books With Generative Artificial Intelligence (AI) Systems

(71) Applicant: QUALCOMM Incorporated, San Diego, CA (US)

(72) Inventor: Kuntal SAMPAT, La Jolla, CA (US)

(21) Appl. No.: 18/403,820

(22) Filed: Jan. 4, 2024

(51) Int. Cl. G06F 3/16; G06F 3/01

(52) U.S. Cl. CPC G06F 3/167; G06F 3/013; G06F 3/165

(57) ABSTRACT

Various embodiments include systems and methods of using an LXM to augment and enhance the reading experience of an eBook with contextual sound and music. A computing device may be configured to use large generative artificial intelligence model (LXM) to analyze eBooks to identify key narrative elements such as settings, mood, themes, character details, location, time period, and sound-effect descriptors (e.g., dialogue intensity, transition points, etc.). The computing device may use the analysis results (or LXM query results) to select a soundscape or sounds and/or music that align with the mood, setting, character traits, and narrative cues identified in the eBook content (e.g., gentle, nature-related sounds for a serene forest setting, intense music for suspenseful scenes, etc.).

### BACKGROUND

Recent advancements in artificial intelligence (AI) and machine learning (ML) technologies have led to the development of increasingly sophisticated models capable of understanding and interpreting complex data structures. These models, commonly known as large generative AI models (LXMs), have a multitude of applications that span across various domains, from natural language processing to computer vision and speech recognition. Their efficacy stems from their ability to learn from massive datasets, gaining an unprecedented depth of understanding and applicability.

### SUMMARY

Various aspects include methods and computing devices implementing the methods for providing an immersive contextual audio effects for an electronic book (eBook). Various aspects may include generating a generative artificial intelligence model (LXM) prompt based on context and narrative elements of a section of the eBook, applying the generated LXM prompt to a local or remote LXM to receive an LXM response, determining context-appropriate sounds for a subsection of the eBook on which a reader is currently focused based on the received LXM response, and outputting the determined context-appropriate sounds on a sound-producing component. In some aspects, generating the generative artificial intelligence model (LXM) prompt may be further based on the section of the eBook, user profile information, and context information.

In some aspects, determining context-appropriate sounds for the subsection of the eBook on which a reader is currently focused based on the received LXM response may include using a sound-generating artificial intelligence (AI) model to generate sounds that match the narrative elements of the subsection of the eBook on which the reader is currently focused. In some aspects, determining context-appropriate sounds for the subsection of the eBook on which a reader is currently focused based on the received LXM response may include determining context-appropriate sounds for the subsection of the eBook on which a reader is currently focused using a sound-generating AI model to generate sounds that may include determining the context-appropriate sounds based on character analysis information included in the received LXM response, in which the character analysis information may characterize at least one of an age, gender, or personality of a character in the subsection of the eBook on which the reader is currently focused.

Some aspects may further include determining the subsection of the eBook on which the reader is focused using at least one or more of an eye-tracking sensor or a gaze-tracking sensor. Some aspects may further include adjusting the context-appropriate sounds in response to determining that the reader is focused on a dialogue-focused passage identified in the received LXM response.

Some aspects may further include determining the subsection of the eBook on which the reader is currently focused using historical data to determine a reading pace, time estimates for sound effects, and transition points in a soundscape based on the determined reading pace. Some aspects may further include determining music for one or more subsections in the section of the eBook based on the received LXM response. Some aspects may further include reducing or halting the music during an intense dialogue or transition sounds to match narrative shifts identified in the received LXM response.

Further aspects may include a computing device having a at least one processor configured with processor-executable instructions to perform operations of any of the methods summarized above. Further aspects may include a non-transitory processor-readable storage medium having stored thereon processor-executable instructions configured to cause at least one processor to perform operations of any of the methods summarized above. Further aspects may include a computing device having means for performing functions of any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1 is a component block diagram illustrating example components of a processing system that may be included in a computing device and configured to implement some embodiments.

FIG. 2 is a component block diagram illustrating an example computing system architecture that may be used for implementing various embodiments.

FIGS. 3 and 4 are process flow diagrams illustrating methods of generating sounds while a person reads an eBook in accordance with some embodiments.

FIG. 5 is a component block diagram illustrating an example computing device in the form of a laptop that is suitable for implementing some embodiments.

FIG. 6 is a component block diagram illustrating an example wireless communication device suitable for use with some embodiments.

FIG. 7 is a component diagram of an example server suitable for implementing some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments may include methods and computing devices performing the methods for generating context-appropriate sounds while a person reads an electronic book (eBook). Various embodiments may include a computing device that includes a memory, a display configured to display eBooks, a sound-producing component (e.g., a speaker or link to headphones, earbuds, etc.), and at least one processor configured to perform method operations. Various embodiments may include generating a generative artificial intelligence model (LXM) prompt based on a section of an eBook, applying the LXM prompt to a local or remote LXM to receive an LXM response, determining sounds for one or more subsections in the section of the eBook based on the received LXM response, determining the subsection of the eBook on which a reader is focused and outputting the determined sounds on the sound-producing component for the determined subsection of the eBook on which the reader is focused. Sounds to be rendered may be determined based on the received LXM response by using a sound-generating artificial intelligence (AI) model that is trained and configured to create sounds that match a narrative of the determined subsection of the eBook on which the reader is focused.

The term “computing device” is used herein to refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo Switch™) media players (e.g., DVD players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IoT) devices, other similar devices that include a programmable processing system that may be configured to provide the functionality of various embodiments.

The term “processing system” is used herein to refer to one or more processors, including multi-core processors, that are organized and configured to perform various computing functions. Various embodiment methods may be implemented in one or more of multiple processors within a processing system as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system also may include software for controlling integrated resources and processors, as well as for controlling peripheral devices.

The term “system in a package” (SIP) is used herein to refer to a single module or package that contains multiple resources, computational units, cores or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “soundscape” is used herein to refer to a performance of sounds and music that creates a sensation of experiencing a particular setting or acoustic environment. A soundscape may include an array of auditory elements, including sounds, sound effects, background sounds, ambient noises, musical compositions, etc.

The term “context-appropriate sounds” is used herein to refer to a spectrum of audio elements specifically designed to enhance the reading experience by aligning with and complementing the narrative, mood, setting, etc. of a particular section in an electronic book (“eBook”). Context-appropriate sounds may include, but are not limited to, a soundscape, ambient sounds that mirror the story's environment, sound effects that correspond to actions or events within the text, musical scores that reflect the emotional tone of the narrative, thematic sounds that are pertinent to the story's genre or historical period, and environmental transitions that indicate changes in setting or time. The integration of such sounds may create an immersive and engaging reading experience by dynamically adapting sounds to the content and context of the eBook thereby generating a soundscape to augment the reader's engagement and comprehension.

The term “large generative AI model” (LXM) is used herein to refer to an advanced computational framework that includes any of a variety of specialized AI models including, but not limited to, large language models (LLMs), large speech models (LSMs), large/language vision models (LVMs), vision language models (VLMs)), hybrid models, and multi-modal models. An LXM may include multiple layers of neural networks with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various embodiments, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some embodiments, the LXM component may be enhanced with or configured to perform an adaptive algorithm that allows the LXM to better understand the contents of an electronic book (eBook), contextual details, user profile data, and the evolving patterns of user engagement, including user interactions and points of focus. In some embodiments, the adaptive algorithms may be performed by the same processing system that manages the core functionality of the LXM and/or may be distributed across multiple independent processing systems.

Various embodiments include computing devices (e.g., smartphones, tablets, e-readers, etc.) that use an LXM to augment and enhance the reading experience of an eBook with context-appropriate sounds (e.g., contextual sound and music, etc.). In some embodiments, the computing device may be configured to use an LXM to analyze eBooks to identify key narrative elements such as settings, mood, themes, character details, location, time period, and sound-effect descriptors (e.g., dialogue intensity, transition points, etc.). The computing device may use the analysis results (or LXM query results) to select context-appropriate sounds (e.g., a soundscape, sounds, music, etc.) that align with the mood, setting, character traits, and narrative cues identified in the eBook content (e.g., gentle, nature-related sounds for a serene forest setting, intense music for suspenseful scenes, etc.) where the user is reading.

In some embodiments, the computing device may be configured to use eye-tracking or gaze-tracking sensors to determine the portion of the text on which the user is focused, and generate and play context-appropriate sounds for the section of text on which the user is focused. For example, the computing device may monitor the user's ocular movements and gaze patterns to identify the text of the eBook being read, identify sounds appropriate for the context of the specific sections on which the user is focused, and output sounds (e.g., a soundscape) including playback of auditory elements (context-appropriate sounds) that is synchronized to align with text that the user is reading. In some embodiments, the computing device may be configured to use historical data (e.g., page turns, scrolling, etc.) to determine the user's reading speed and estimate or refine the timing of playing sound effects and music transitions so that soundscapes and/or music are synchronized with the text being read by the user from moment to moment. For example, the computing device may change the music to match the emotional intensity of a passage or the pace of an action-packed sequence as the context of the text being read changes. In some embodiments, the computing device may be configured to dynamically adapt in real-time to the user's reading pace and focus within the eBook. For example, if the user's gaze slows or lingers over a particular section of text, the computing device may continue to play the context-appropriate sounds and/or music until the user's gaze moves on.

By integrating eye-tracking technology or other methods for monitoring, determining, or estimating reading speed, the computing system may adapt in real time to the reader's pace and focus within the book. For example, the computing device may adjust the music to enhance the emotional impact of a particularly intense or emotional passage in response to determining that the reader is lingering on that passage. As another example, the computing device may adjust the music to become more dynamic and fast-paced in response to determining that the reader is quickly flipping through pages during an action-packed sequence.

In some embodiments, the computing device may be configured to generate a unique auditory experience each time a reader opens an eBook. The computing device may adjust the context-appropriate sounds (e.g., auditory elements, soundscape, etc.) based on new reading patterns or changes in the reader's preferences, such as variations in reading speed or time of day.

In some embodiments, the computing device may be configured to provide the same auditory experience for the same passage in each subsequent reading. In some embodiments, the computing device may be configured to provide a different auditory experience for the same passage in each subsequent reading. Thus, the computing device may allow the user to experience reading the eBook again while hearing different thematic interpretations of the same text.

In some embodiments, the computing device may be configured to personalize the transition points in soundscapes according to the user's reading speed.

In some embodiments, the computing device may be configured to actively track the words being read and apply LXM analysis within the context of surrounding paragraphs to identify key elements, such as mood and setting. In some embodiments, the computing device may be configured to use a sound-generating AI model to create appropriate background sounds that match the narrative setting (e.g., historical city sounds, outdoor ambient noises, etc.).

In some embodiments, the computing device may be configured to make dynamic and real-time adjustments to the audio that is played to enhance the user experience. In some embodiments, the computing device may be configured to adjust the audio that is played while the user is reading dialogue-focused passages. For example, the computing device may reduce the volume or eliminate background music and/or soundscape to enhance reader focus during intense passages. As another example, the computing device may reduce or halt music during intense dialogue or transition sounds to match narrative shifts.

In some embodiments, the computing device may be configured to identify and use descriptions of specific sound effects associated with the eBook. For example, if the text being read (or that soon will be read) by the user describes sounds heard by a character in the eBook (e.g., rain falling on an umbrella, the roar of an automobile engine, distant thunder, waves crashing on a beach, etc.), the computing device may use the sound descriptions in the eBook to generate a prompt for the LXM to generate matching or similar sounds that are then played to provide a soundscape consistent with the text as it is read.

In some embodiments, the computing device may be configured to use the LXM to perform character analysis and adjust the audio experience based on character being described or speaking in the text being read (or that soon will be read) by the user, such as based on details about the character described in the text, such as age, gender, emotional state, and/or personality. In some embodiments, the computing device may be configured to perform context-based and profile-based operations, using context information and user profile data to intelligently determine the sounds and music to play.

In some embodiments, the computing device may be configured to create and use personalized user profiles based on historical and user data. The computing device may use the user profiles to generate enhanced prompts that cause the LXM to generate output that tailors the auditory experience to individual preferences and behaviors of the current user of the computing device. In some embodiments, the computing device may be configured to collect, analyze, and use implicit and/or explicit user feedback to refine the user's profile and/or use to adjust future sound and/or music selection or playback timing for various text context. In some embodiments, the computing device may be configured to exchange data with a cloud-based system to track user's reading patterns and create personalized soundscapes for each reader.

In some embodiments, the computing device may be configured to use an AI model that is trained using a robust dataset covering various literary settings and context-appropriate soundscapes. For example, the AI model may be trained using a training dataset that includes a variety of selections of text from a variety of books that are matched to audio files or LXM prompts that have been identified by human reviewers to be context-appropriate. In some embodiments, the AI model may be fine-tuned in a similar manner for specific books, writers, genres, literary categories, time periods, etc.

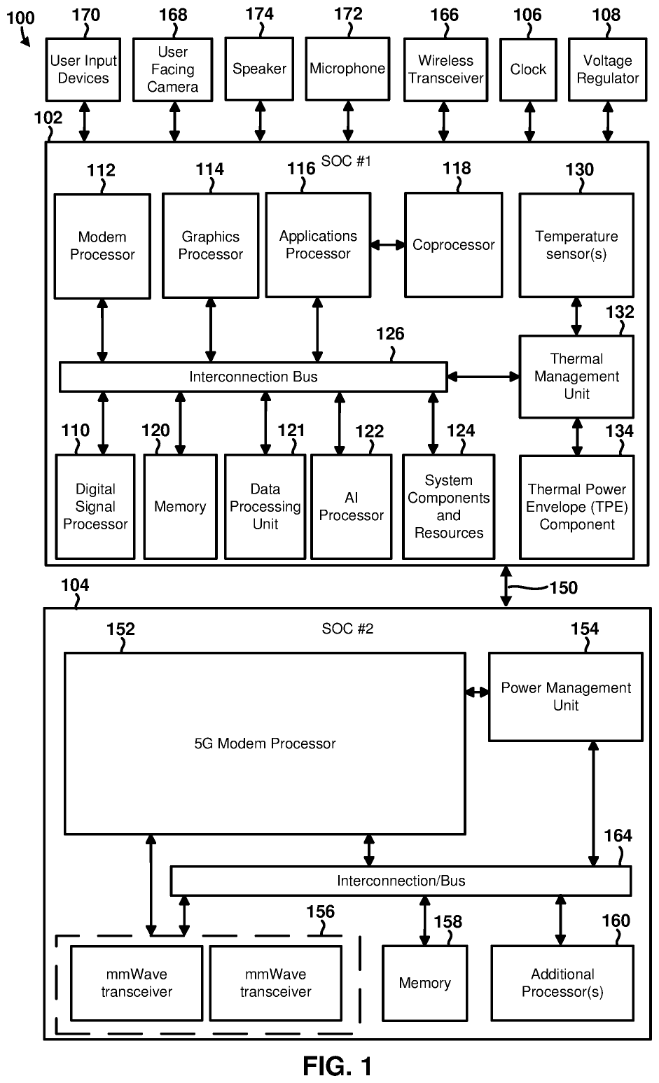

Various embodiments may be implemented in a processing system of a computing device that may include a number of single-processor and multiprocessor devices, which may be implemented in an SOC or SIP. FIG. 1 illustrates an example processing system 100 implemented in a SIP that may be used in user computing devices implementing various embodiments.

With reference to FIG. 1, the illustrated example processing system 100 includes two SOCs 102, 104, that may be coupled to a clock 106, a voltage regulator 108, a wireless transceiver 166, a user facing camera 168, user input devices 170 (e.g., a touch-sensitive display, a touch pad, a mouse, etc.), a microphone 172, and a sound producing component such as a speaker 174. The first and second SOC 102, 104 may communicate via interconnection bus 150. Various processors 110, 112, 114, 116, 118, 121, 122, may be interconnected to each other and to one or more memory elements 120, system components and resources 124, and a thermal management unit 132 via an interconnection bus 126, which may include advanced interconnects such as high-performance networks-on-chip (NOCs). Similarly, the processor 152 may be interconnected to the power management unit 154, the mmWave transceivers 156, memory 158, and various additional processors 160 via the interconnection bus 164. These interconnection buses 126, 150, 164 may include an array of reconfigurable logic gates and/or implement a bus architecture (e.g., CoreConnect, AMBA, etc.). Communications may be provided by advanced interconnects, such as NOCs.

In various embodiments, any, or all of the processors 110, 112, 114, 116, 121, 122, in the system may operate as the SoC's main processor, central processing unit (CPU), microprocessor unit (MPU), arithmetic logic unit (ALU), etc. One or more of the coprocessors 118 may operate as the CPU.

In some embodiments, the first SOC 102 may operate as the central processing unit (CPU) of the mobile computing device that carries out the instructions of software application programs by performing the arithmetic, logical, control and input/output (I/O) operations specified by the instructions. In some embodiments, the second SOC 104 may operate as a specialized processing unit. For example, the second SOC 104 may operate as a specialized 5G processing unit responsible for managing high volume, high speed (e.g., 5 Gbps, etc.), and/or very high-frequency short wavelength (e.g., 28 GHz mmWave spectrum, etc.) communications.

The first SOC 102 may include a digital signal processor (DSP) 110, a modem processor 112, a graphics processor 114, an application processor 116, one or more coprocessors 118 (e.g., vector co-processor, CPUCP, etc.) connected to one or more of the processors, memory 120, data processing unit (DPU) 121, artificial intelligence processor 122, system components and resources 124, an interconnection bus 126, one or more temperature sensors 130, a thermal management unit 132, and a thermal power envelope (TPE) component 134. The second SOC 104 may include a 5G modem processor 152, a power management unit 154, an interconnection bus 164, a plurality of mmWave transceivers 156, memory 158, and various additional processors 160, such as an applications processor, packet processor, etc.

Some or all of the processors 110, 112, 114, 116, 118, 121, 122, 121, 122, 152, 160 of a processing system 100 may include one or more cores, and each processor/core may perform operations independent of the other processors/cores. For example, the first SOC 102 may include a processor that executes a first type of operating system (e.g., FreeBSD, LINUX, OS X, etc.) and a processor that executes a second type of operating system (e.g., MICROSOFT WINDOWS 11). In addition, any, or all of the processors 110, 112, 114, 116, 118, 121, 122, 121, 122, 152, 160 may be included as part of a processor cluster architecture (e.g., a synchronous processor cluster architecture, an asynchronous or heterogeneous processor cluster architecture, etc.).

Any or all of the processors 110, 112, 114, 116, 118, 121, 122, 121, 122, 152, 160 may operate as the CPU of the mobile computing device. In addition, any, or all of the processors 110, 112, 114, 116, 118, 121, 122, 121, 122, 152, 160 may be included as one or more nodes in one or more CPU clusters. A CPU cluster may be a group of interconnected nodes (e.g., processing cores, processors, SOCs, SIPs, computing devices, etc.) configured to work in a coordinated manner to perform a computing task. Each node may run its own operating system and contain its own CPU, memory, and storage. A task that is assigned to the CPU cluster may be divided into smaller tasks that are distributed across the individual nodes for processing. The nodes may work together to complete the task, with each node handling a portion of the computation. The results of each node's computation may be combined to produce a final result. CPU clusters are especially useful for tasks that can be parallelized and executed simultaneously. This allows CPU clusters to complete tasks much faster than a single, high-performance computer. Additionally, because CPU clusters are made up of multiple nodes, they are often more reliable and less prone to failure than a single high-performance component.

The first and second SOC 102, 104 may include various system components, resources, and custom circuitry for managing sensor data, analog-to-digital conversions, wireless data transmissions, and for performing other specialized operations, such as decoding data packets and processing encoded audio and video signals for rendering in a web browser. For example, the system components and resources 124 of the first SOC 102 may include power amplifiers, voltage regulators, oscillators, phase-locked loops, peripheral bridges, data controllers, memory controllers, system controllers, Access ports, timers, and other similar components used to support the processors and software clients running on a computing device. The system components and resources 124 may also include circuitry to interface with peripheral devices, such as cameras, electronic displays, wireless communication devices, external memory chips, etc.

The first and/or second SOCs 102, 104 may further include an input/output module (not illustrated) for communicating with resources external to the SOC, such as the clock 106, the voltage regulator 108, the wireless transceiver 166 (e.g., cellular wireless transceiver, Bluetooth transceiver, etc.), the user facing camera 168, user input devices 170 (e.g., a touch-sensitive display, a touch pad, a mouse, etc.), a microphone 172, and a speaker 174. Resources external to the SOC (e.g., clock 106, voltage regulator 108, wireless transceiver 166, user facing camera 168, user input devices 170, microphone 172, and speaker 174) may be shared by two or more of the internal SOC processors/cores. The first and/or second SOCs 102, 104 be configured with modules for processing data received from the user facing camera 168 and user input devices 170 to track a user's focus as described herein. Further, the

In addition to the example processing system 100 discussed above, various embodiments may be implemented in various computing systems, including a single processor, multiple processors, multicore processors, or any combination thereof.

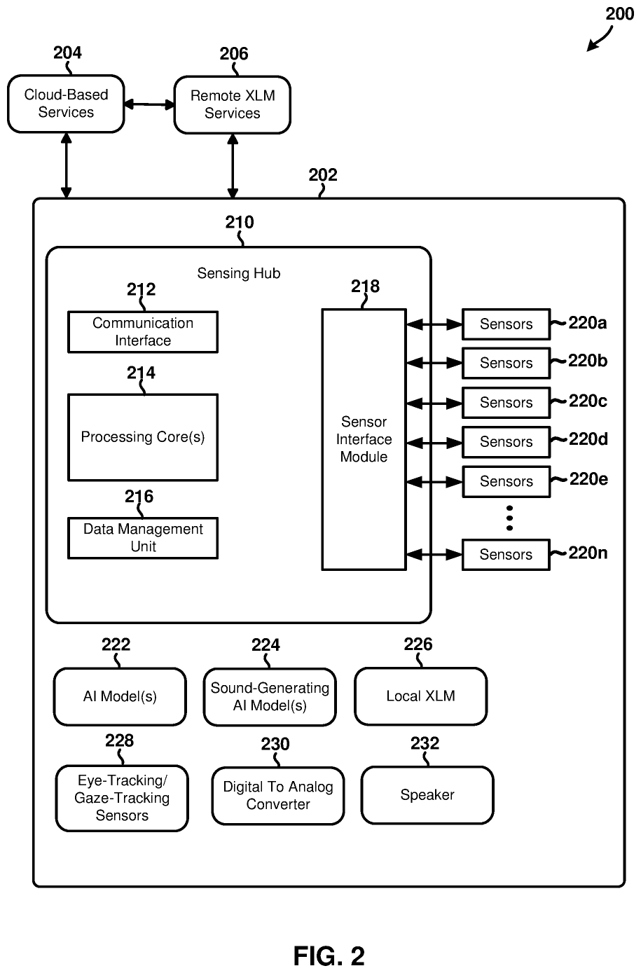

FIG. 2 illustrates an example system 200 architecture that may be used for implementing various embodiments. With reference to FIGS. 1 and 2, the system 200 may include a user computing device 202 including a processing system 100 communicatively coupled to cloud-based services 204 components and a remote LXM services 206 component. The user computing device 202 may include a sensing hub 210, a multitude of sensors 220a-220n, AI model(s) 222, sound-generating AI model(s) 224, a local LXM 226 component, eye-tracking/gaze-tracking sensors 228, a digital to analog converter 230, and a speaker 232.

The sensing hub 210 may be a specialized component on the user computing device 202 that is dedicated to gathering sensor data (e.g., multi-sensory data) and/or configured to compile or collate various types of sensory inputs such as auditory signals from a microphone, visual data from a camera, or biometric indicators from wearable devices. The sensing hub 210 may be configured to interface with a multitude of sensors 220a-220n through a dedicated Sensor Interface Module 218. Examples of such sensors 220a-220n include microphones, cameras, GPS, IMU, keyboards, touchscreens, brain-computer interfaces, controllers, eye trackers, haptic sensors, heart rate monitors, accelerometers for linear motion detection, gyroscopes for assessing angular velocity and positioning, temperature sensors for ambient conditions, humidity detectors, barometers, ambient light gauges, proximity detectors, orientation trackers, infrared sensors, physical activity monitors, distance measurers, geolocation trackers, environmental detectors, biometric identifiers (such as those for fingerprints, retinal scans, and facial recognition), blood pressure and glucose monitors, alcohol detectors, and specialized sensors such as those for acidity assessment, thermal imaging, spatial mapping, deflection gauging, and load sensing, etc.

The sensing hub 210 may also include a data management unit 216 for data storage and retrieval, one or more processing cores 214 for computational tasks, and a communication interface 212 for coordinating with the main processor of the computing system. The sensing hub 210 may be configured to perform real-time data processing, use data from different sensors to derive context or develop a contextual understanding of the device's surroundings, user's condition, etc., generate composite information based on the multi-sensor data and contextual information, use the generated composite information to generate a user profile or a user context, generate or update an LXM prompt, generate or update LXM output, adjust device settings, trigger specific actions on the computing system, or perform other similar operations.

The sensing hub 210 may continually capture inputs, data, and information from diverse sensors or modalities that offer a broad spectrum of sensor data. In some embodiments, the user computing device 202 may be configured to use the information collected by the sensing hub 210 in conjunction with information captured by any of the sensors and input/output devices accessible to the user to structure the LXM prompts and content. In some embodiments, the user computing device 202 may be configured to analyze and combine data from these diverse sources to obtain comprehensive insights into the user's context when reading the eBook. The data from the sensors may be real-time (or near real-time) data and/or historical sensed/collected data.

The user computing device 202 may be configured to work in conjunction with a cloud-based system 204 to track user's reading patterns and/or create context-appropriate sounds (e.g., personalized soundscapes, etc.) for each reader. When a user downloads a book, the cloud-based system 204 may begin tracking the user's reading patterns. The context-appropriate sounds generated for each book may be pre-determined tracks and/or may be dynamically created in response to the individual reader's experience. This customization may enable the auditory backdrop to be custom-tailored to each individual reader.

The user computing device 202 may generate and send enhanced LXM prompts to a remote LXM 206 and/or a local LXM 226 to analyze an eBook (or specific chapters or sections of the eBook). For example, the user computing device 202 may use the LXM 206, 226 to identify narrative settings, mood, themes, character details, location, time period, and specific sound-effect descriptors such as dialogue intensity and transition points within the narrative. The user computing device 202 may use the results of this analysis to select context-appropriate sounds that align with the mood, setting, character traits, and/or narrative cues identified in the eBook content. For example, if a chapter is set in a serene forest, the LXM query results may suggest gentle, nature-related sounds and calming music to complement the setting. As another example, in a scene of suspense or action, the LXM query results may suggest more intense music and sound effects to enhance the mood. The user computing device 202 may use the suggestions in the LXM query results to select and play the sounds and music as the user reads the eBook to create an immersive auditory experience.

In some embodiments, the user computing device 202 may use integrated eye-tracking or gaze-tracking sensors 228 to determine the specific portions of the content the user is focusing on, allowing for precise matching of sounds to the text being read. In some embodiments, the user computing device 202 may use historical data characterizing the user's reading speed to estimate the timing for sound effects and music transitions. The user computing device 202 may also track page turns or scrolling to refine these timing estimates and to help ensure that the sound and music transitions are smooth and synchronous with the reader's pace.

The user computing device 202 may generate a unique auditory experience each time a reader opens an eBook. The user computing device 202 may create a distinct soundscape each time the user reads the eBook to add a dynamic layer to the reading experience and make every interaction with the book new and engaging. For example, if a reader revisits a previously read chapter, the system might not replay the exact same set of sounds or music as before. Instead, the computing device 202 may adjust the auditory elements based on any new reading patterns or changes in the reader's preferences that have been detected since the last session. This may include variations in reading speed, different times of day (e.g., providing a more subdued soundscape for night-time reading, etc.), changes in the reader's mood, etc.

The user computing device 202 may be configured to allow for the exploration of different thematic interpretations of the same text. A passage that was once accompanied by a somber tune could, in subsequent readings, be paired with a more hopeful melody, offering a new perspective on the narrative. The unique experience generated every time may also mean that each reader's journey through the book is distinct. Two readers of the same eBook may have very different auditory experiences, each tailored to their individual reading habits and preferences.

In some embodiments, the transition points in the soundscapes may be personalized and/or adjusted according to the user's reading speed so that faster readers might experience quicker transitions between soundscapes, while slower readers would have a more prolonged immersion in each auditory setting.

In some embodiments, the user computing device 202 may be configured to actively track the words being read, apply an LXM to analyze the text within the context of the surrounding paragraphs and identify key elements (e.g., mood, location, year, whether the text is descriptive or dialogic, etc.). For example, the user computing device 202 may recognize a scene set in Victorian England with a somber mood and adjust the auditory experience accordingly.

In some embodiments, the user computing device 202 may be equipped with a sound-generating AI model 224 that is configured to generate appropriate background sounds. For example, the sound-generating AI model 224 may generate sounds of horses and buggies if the narrative is set in a bustling city of the past and generate sounds of cars and urban life if the narrative is set in a modern city. As another example, the sound-generating AI model 224 may generate ambient noises (e.g., sounds of birds tweeting, waves on a beach, wind through trees, etc.) that enhance the atmosphere in scenes set outdoors. In some embodiments, the sound-generating AI model 224 may generate and output a digital audio file, which may be converted by a digital to analog converter 230 into analog signals that are provided to a speaker 232 to audibly output the generated sounds. Together, the digital to analog converter 230 coupled to the speaker 232 may constitute a sound producing component.

The user computing device 202 may be configured to determine the pace and nature of the dialogue. The user computing device 202 may reduce, minimize, or eliminate background music for passages with intense dialogue in which readers often immerse themselves deeply into the text. This may help the readers focus, as readers may be “hearing” the dialogue in their minds without needing additional auditory input.

In some embodiments, the eBook may include descriptions of specific sound effects related to the scene. The user computing device 202 may identify these descriptions within the text and use the descriptions to select corresponding sound effects or generate, such as using the description in an LXM prompt, to generate context-appropriate sounds to enhance the reading experience. For example, the user computing device 202 may select or generate and then play subtle rain sounds if the text describes the sound of rain against a window in a particular scene being read by the user.

In some embodiments, the user computing device 202 may be configured to perform character analysis based on descriptions and dialog of characters in a section being read by the user. For example, the user computing device 202 may use the LXM to determine the age, gender, and personality of the characters involved in a scene and adjust the sound accordingly. As a further example, the presence of an elderly woman or a young man in the narrative may influence the choice of background music or ambient sounds.

In some embodiments, the user computing device 202 may be configured to support dynamic and real-time adjustments of the audio experience. For example, the user computing device 202 may reduce the volume or halt the playing of music to prevent distraction while the user is reading passages of intense dialogue. The user computing device 202 may smoothly transition sounds to match shifts in the narrative and synchronize effects with the text as it is read.

In some embodiments, the user computing device 202 may be configured to perform context-based and/or profile-based operations, which may include collecting, generating, updating, and/or using context information and user profile information to generate enhanced prompts and/or otherwise intelligently determine the sounds and/or music to play.

In some embodiments, the user computing device 202 may be configured to collect and use historical data and user data to generate a personalized user profile for the user and generate enhanced prompts for the L×M system (or intelligently select the sounds/music) based on the user profile of a current reader. In some embodiments, the user computing device 202 may generate enhanced prompts that obfuscate the personalized user data and/or do not include sensitive or private personal information. In some embodiments, the computing system may be configured to generate user profiles that include attributes for characterizing and understanding the unique preferences, behaviors, and needs of each user. For example, a user profile may include an age attribute, response length attribute, response flavor attribute, and a temperature attribute. The age attribute may be used to distinguish between a child or adult user, to modulate content appropriateness, etc. The response length attribute may be used to determine whether outputs should be brief or comprehensive. The response flavor attribute may be used for adjusting the tone to be relaxed, professional, etc. based on the user's preference. The temperature attribute may be used to adjust the output style to be more logical or creative based on user preferences.

In some embodiments, the user computing device 202 may be configured to distinguish and differentiate between individual user profiles to manage multiple users accessing and using the same user end device. In some embodiments, the computing system may be configured to generate and continuously update the user profiles.

In some embodiments, the user computing device 202 may be configured to capture information that characterizes user interactions with LXM-generated content, extract metrics such as engagement time and user reactions to distinct sections of the content, send the extracted metrics to the L×M system as feedback, and/or use the extracted metrics to select more relevant sounds or music.

In some embodiments, the user computing device 202 may be configured to incorporate user feedback. For example, the user computing device 202 may allow readers to adjust their audio preferences during playback of the sounds or music. The user computing device 202 may use this feedback to refine future sound selection/generation and playback timing. As such, the user computing device 202 may dynamically adapt to the content of the eBook and the reader's preferences as they progress, ensuring that the auditory enhancements remain contextually appropriate and aligned with the reading experience.

The user computing device 202 may capture implicit feedback through the sensing hub (e.g., time spent on content, user facial expressions, heart rate changes), and/or capture explicit feedback from the user (e.g., turning volume up, down or off, likes, dislikes, comments, etc.). The user computing device 202 may analyze collected feedback to determine user sentiments (e.g., satisfactory, unsatisfactory, confusing, amusing, etc.).

In some embodiments, the user computing device 202 may be configured to train the AI model 222 to perform the above-described functions. The AI model 222 may be trained using a robust dataset encompassing a wide range of literary settings, moods, characters, and actions that are matched to context-appropriate soundscapes (e.g., music, background sounds, etc.). Such a training dataset may be generated by people reading selections of various books and associating the selections with context-appropriate sounds, music or LXM prompts. In some embodiments, the AI model 222 may be pre-trained on a dataset based on general literary themes and genres matched to context-appropriate soundscapes.

In some embodiments, upon downloading an eBook or indicating an intention to read a specific eBook, the AI model 222 may undergo a retraining or fine-tuning phase. This phase may allow the AI model 222 to tailor its context-appropriate soundscape output more closely to the specific eBook, ensuring a highly customized and relevant auditory experience. The AI model 222 may learn to recognize the unique aspects of the eBook's narrative, such as specific character traits, historical settings, or thematic elements, and adjust the features of the sound-generating AI model 224 accordingly.

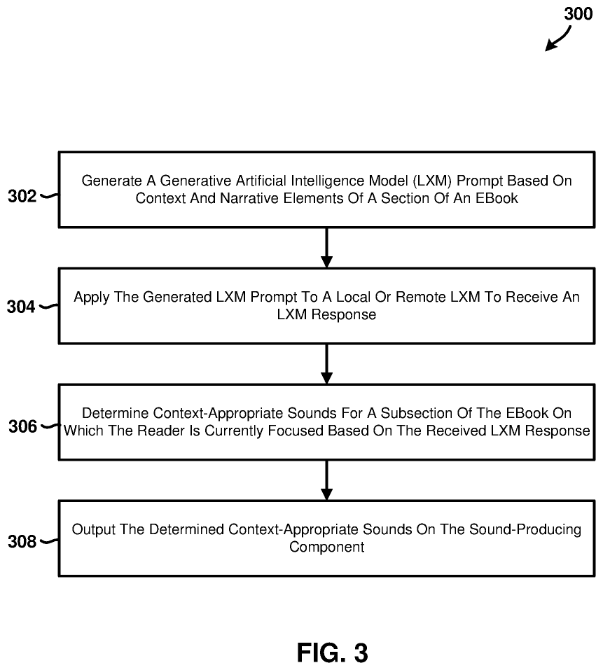

FIG. 3 is a process flow diagram illustrating a method 300 of using an LXM to augment and enhance the reading experience of an eBook with contextual sound and music. With reference to FIGS. 1-3, method 300 may be performed in a processing system (e.g., 100) of a computing device by at least one processor (e.g., 110, 112, 114, 116, 118, 121, 122, 152, 160, 214, etc.), and other components or subsystems described herein. Means for performing the functions of the operations in method 300 may include a processing system 100 including at least one processor 110, 112, 114, 116, 118, 121, 122, 152, 160, 214, and other components or subsystems described herein. Further, at least one processor in a processing system 100 may be configured with software or firmware to perform some or all of the operations of the method 300. In order to encompass the alternative configurations enabled in various embodiments, the hardware implementing any or all of the method 300 is referred to herein as “at least one processor” of a processing system.

In block 302 the at least one processor may generate a generative artificial intelligence model (LXM) prompt based on context and narrative elements of a section of an eBook. In various embodiments, the at least one processor may generate the LXM prompt based on specific sound-effect descriptors within the eBook section, user profile information (e.g., historical reading patterns and preferences, etc.), and/or context information (e.g., the time of day, the reader's current emotional state, etc.).

In block 304, the at least one processor may apply the generated LXM prompt to a local or remote LXM to receive an LXM response in the form of sounds to be played by the computing device. The LXM may be trained to analyze key narrative elements such as settings, mood, themes, character details, and specific sound-effect descriptors within the eBook section to generate the LXM response. As further examples, the LXM may be trained to utilize advanced natural language processing techniques to discern subtleties in the text, such as the underlying emotional tone or the historical context of the setting. The LXM may also be trained to categorize dialogue intensity and narrative pace, identify shifts in the storyline that could influence the auditory experience. In some embodiments, the LXM may be trained to compare the eBook section being read (or will soon be read) with similar literary passages from its training data to infer suitable sound effects and/or musical themes, which can be generated for playing by the processing system.

The LXM responses may include a range of auditory cues and suggestions, including but not limited to specific genres of music, types of ambient sounds, tempo or volume adjustments tailored to the narrative's current mood and pace, etc. For example, the LXM response for a serene forest scene might be a selection or prompt to generate gentle, nature-related sounds and calming music, while the LXM response for a suspenseful chapter may be a selection or prompt to generate intense, dramatic music. In addition, the LXM responses may include cues for sound effects that align with particular actions or events described in the text, such as the sound of rain in a melancholic scene or bustling city noises for an urban setting.

In block 306, the at least one processor may determine context-appropriate sounds for a subsection of the eBook on which the reader is currently focused based on the received LXM response. For example, if a subsection of the eBook describes a tranquil beach scene, the at least one processor may select or generate sounds that include gentle ocean waves, seagulls, and a soft, calming melody to enhance the reader's sensory experience of this setting. If the subsection shifts to a bustling cityscape, the at least one processor may adapt by selecting or generating sounds that encapsulate the essence of an urban environment, such as the distant hum of traffic, the occasional honking of cars, subtle sirens in the background, the murmur of a crowd, or other sounds that serve to transport the reader into the heart of a city or mirror the hustle and bustle described in the text.

As another example, the at least one processor may choose or generate sound effects that build tension (e.g., a slowly escalating music score, the sound of footsteps echoing in a hallway, doors creaking, a soft wind whistling, etc.) in response to determining that the eBook narrative transitioned into a suspenseful or thrilling segment. In another example, the at least one processor may select or generate period-accurate sounds for sections of the eBook that depict historical settings. For example, in a medieval setting, the processor may select or generate sounds depicting clashing swords, the neighing of horses, or the bustling noise of a market square. The at least one processor may choose sounds that depict the hum of futuristic machinery, the beeping of high-tech devices, or the ambient noise of a spacecraft for a science fiction setting.

In block 308, the at least one processor may output the determined context-appropriate sounds on the sound-producing component. For example, the at least one processor may output on a speaker of the computing device a lively mix of voices, the clatter of goods, and background music that reflects a cultural setting of a marketplace for a scene depicting a bustling marketplace.

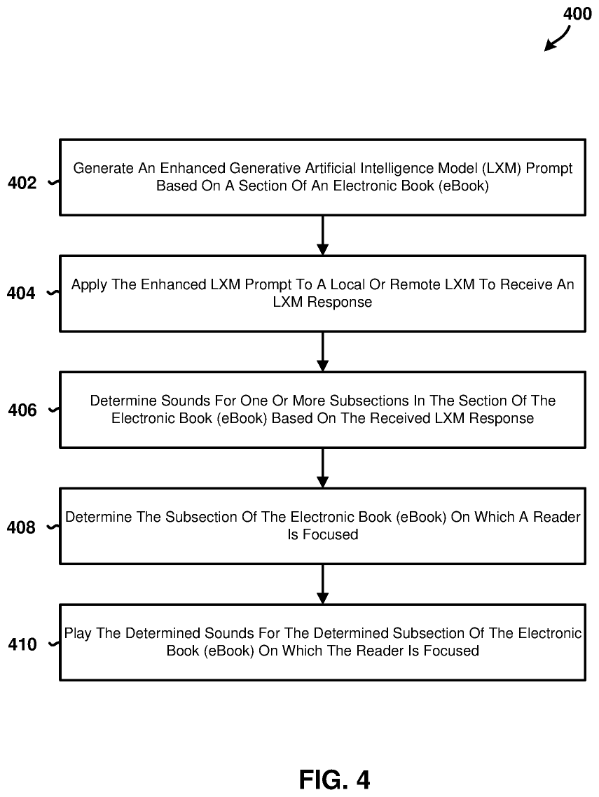

FIG. 4 is a process flow diagram illustrating a method 400 of using an LXM to augment and enhance the reading experience of an eBook with contextual sound and music. With reference to FIGS. 1-4, the method 400 may be performed in a processing system (e.g., 100) of a computing device by at least one processor (e.g., 110, 112, 114, 116, 118, 121, 122, 152, 160, 214, etc.), and other components or subsystems described herein. Means for performing the functions of the operations in method 400 may include a processing system 100 including at least one processor 110, 112, 114, 116, 118, 121, 122, 152, 160, 214, and other components or subsystems described herein. Further, at least one processor in a processing system 100 may be configured with software or firmware to perform some or all of the operations of the method 400. In order to encompass the alternative configurations enabled in various embodiments, the hardware implementing any or all of the method 400 is referred to herein as “at least one processor” of a processing system.

For the sake of clarity and ease of presentation, methods 300 and 400 are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. to produce a modified or alternative result or solution. The presentation of individual methods, blocks, operations, etc. should not be interpreted as mutually exclusive, limiting, or as being required unless expressly recited as such in the claims.

In block 402 the at least one processor may generate an enhanced generative artificial intelligence model (LXM) prompt based on a section of an electronic book (eBook). The enhanced LXM prompt may be a prompt that is generated for submission to an LXM based on the content of an eBook being read by a user, context information extracted from the text of the eBook being read by the user, and/or user profile information. In some embodiments, the at least one processor may generate the enhanced LXM prompt based on the section of the eBook, specific sound-effect descriptors within the eBook section, user profile information (e.g., historical reading patterns and preferences, etc.), and/or context information (e.g., the time of day, the reader's current emotional state, etc.). In some embodiments, in block 402, the at least one processor may perform any or all of the operations discussed above with reference block 302.

In block 404, the at least one processor may apply the enhanced LXM prompt to a local or remote LXM to receive an LXM response. For example, the at least one processor may submit the enhanced LXM prompt to a generative AI model specializing in sound and narrative analysis. This LXM may interpret the prompt to analyze the eBook's content, user preferences, and contextual information, and generate a response that includes suitable sound suggestions, narrative insights, and potential emotional cues relevant to the specific section of the eBook. The LXM response may be tailored to the textual content of the eBook, the reader's unique profile, current reading environment, etc. In some embodiments, in block 404, the at least one processor may perform any or all of the operations discussed above with reference block 304.

In block 406, the at least one processor may determine sounds for one or more subsections in the section of the eBook based on the received LXM response. For example, the at least one processor may select or generate sounds that align with the LXM's recommendations, which may include filtering and fine-tuning the suggested sounds to best match the eBook section's atmosphere and the reader's preferences. For example, the at least one processor may select or generate soft instrumental music, subtle nature sounds, or a gentle ambient noise to create a serene reading environment in response to receiving an LXM response that indicates a tranquil and reflective mood.

In some embodiments, the at least one processor may use the sound-generating AI model 224 to generate sounds that match a narrative of the determined subsection of the eBook on which the reader is focused. For example, in a scene depicting a bustling marketplace, the AI model 224 may generate a lively mix of voices, the clatter of goods, and background music that reflects the cultural setting of the marketplace, thereby transporting the reader directly into the scene.

In some embodiments, the at least one processor may determine the sounds based on character analysis information included in the received LXM response. In some embodiments, the character analysis information may characterize at least one of an age, gender, emotional state, and/or personality of a character in the one or more subsections of the eBook. For example, if a key character in a subsection is a young, energetic individual, the processor may generate vibrant and upbeat music to mirror the character's energy. Conversely, for a scene centered around an elderly, contemplative character, the processor may generate softer, slower-paced music to reflect the character's demeanor or incorporate subtle background sounds that evoke a sense of introspection (e.g., reflective notes of a piano, vintage record player sounds, etc.).

In block 408, the at least one processor may determine the subsection of the eBook on which a reader is focused. In some embodiments, the at least one processor may determine the subsection of the eBook on which a reader is focused by using an eye-tracking/gaze-tracking sensor 228. In some embodiments, the at least one processor may determine a reading pace, time estimates for sound effects, and transition points in a soundscape based on the determined reading pace.

In block 410, the at least one processor may play the generated sounds for the determined subsection of the eBook on which the reader is focused. The at least one processor may also dynamically adjust the sounds, such as by lowering the volume in response to determining that the reader is focused on a dialogue-focused passage of the eBook. The at least one processor may also reduce or halt the music during an intense dialogue or transition sounds to match narrative shifts identified in the received LXM response.

In some embodiments, the computing device may be configured to connect with a cloud-based system, download an eBook, and track the user's reading patterns via the cloud-based system. In such embodiments, the computing device may generate or retrieve user profiles (including attributes such as age, preferred response length, tone, style, etc.), generate and send enhanced LXM prompts to the remote or local LXM for analyzing the eBook, determining narrative settings, mood, themes, character details, location, time period, specific sound-effect descriptors, etc., determining context such as the mood, location, era, dialogue intensity, transition points, etc. The computing device may use the LXM results to select or generate context-appropriate sounds and music that align with the narrative and/or use suggestions from LXM to create an immersive auditory experience.

The computing device may use eye-tracking or gaze-tracking sensors to monitor the reader's focus on specific text portions, use historical data to estimate and refine timing for sound effects and music transitions, and track page turns and scrolling to synchronize sound and music with the reader's pace. The computing device may generate unique auditory experiences for each reading session, adjust to new reading patterns or preference changes, adjust soundscapes based on variations in reading speed, time of day, and reader's mood. The computing device may perform character analysis using an LXM to adjust sound based on character traits, determine the pace and nature of dialogue, adjust background music or sound effects, use a sound-generating AI model to generate appropriate background sounds based on narrative settings, generate ambient noises or specific sound effects related to the scene, capture implicit feedback (e.g., time spent, facial expressions, heart rate) and explicit feedback (e.g., volume adjustments, likes, dislikes), analyze feedback to refine future sound/music selection and playback timing, train AI models using a robust dataset covering various literary settings and soundscapes, retrain or fine-tune the AI models for specific books, genres, or themes (e.g., upon user request, etc.), play the selected or generated sounds and music in synchronization with the eBook content (adapting dynamically to the reading experience), and ensure that enhanced prompts and user data handling maintain user privacy and do not include sensitive personal information.

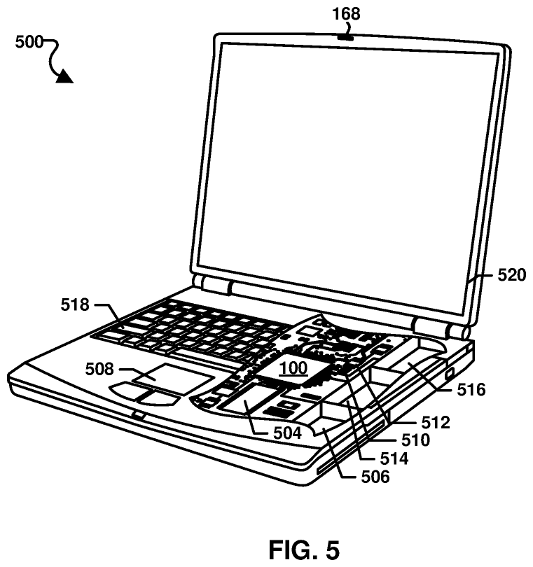

Various embodiments (including, but not limited to, embodiments described above with reference to FIGS. 1-4) may be implemented in a wide variety of wireless devices and computing systems including a laptop computer 500, an example of which is illustrated in FIG. 5. With reference to FIGS. 1-5, a laptop computer may include a SOC 102 coupled to volatile memory 504 and a large capacity nonvolatile memory, such as a disk drive 506 of Flash memory. The laptop computer 500 may include a touchpad touch surface 508 that serves as the computer's pointing device, and thus may receive drag, scroll, and flick gestures. Additionally, the laptop computer 500 may have one or more antenna 510 for sending and receiving electromagnetic radiation that may be connected to a wireless data link and/or cellular telephone transceiver 512 coupled to the processing system 100. The computer 500 may also include a BT transceiver 514, a compact disc (CD) drive 516, a keyboard 518, a display 520, and a user facing camera 168 all coupled to the processing system 100. Other configurations of the computing device may include a computer mouse or trackball coupled to the processor (e.g., via a universal serial bus (USB) input) as are well known, which may also be used in conjunction with various embodiments.

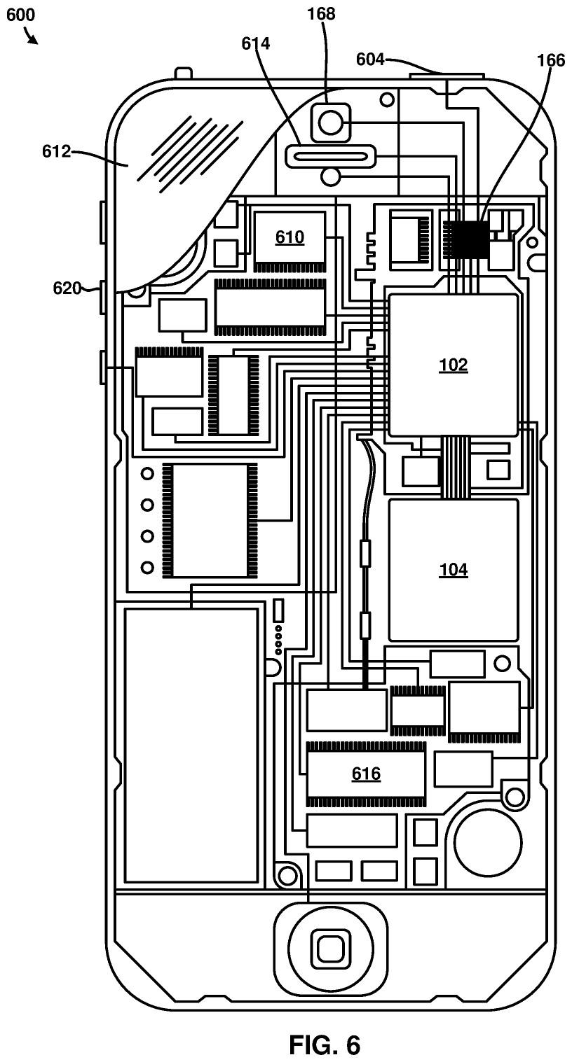

FIG. 6 is a component block diagram of a computing device 600 suitable for use with various embodiments. With reference to FIGS. 1-6, various embodiments may be implemented on a variety of computing devices 600, an example of which is illustrated in FIG. 6 in the form of a smartphone. The computing device 600 may include a first SOC 102 coupled to a second SOC 104. The first and second SoCs 102, 104 may be coupled to internal memory 616, a display 612, a user facing camera 168, and to a speaker 614. The first and second SOCs 102, 104 may also be coupled to at least one subscriber identity module (SIM) 640 and/or a SIM interface that may store information supporting a first 5GNR subscription and a second 5GNR subscription, which support service on a 5G non-standalone (NSA) network.

The computing device 600 may include an antenna 604 for sending and receiving electromagnetic radiation that may be connected to a wireless transceiver 166 coupled to one or more processors in the first and/or second SOCs 102, 104. The computing device 600 may also include menu selection buttons or rocker switches 620 for receiving user inputs.

The computing device 600 also includes a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first and second circuitries 102, 104, wireless transceiver 166 and CODEC 610 may include a digital signal processor (DSP) circuit (not shown separately).

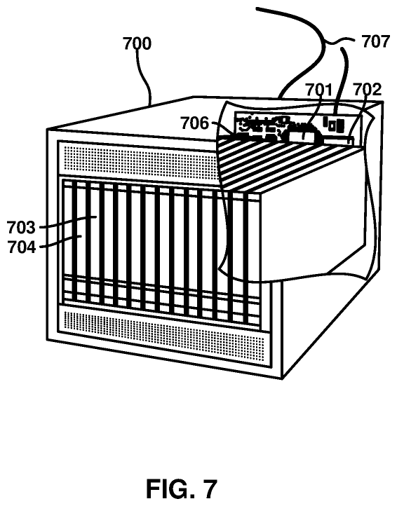

Some embodiments may be implemented on any of a variety of commercially available computing devices, such as the server computing device 700 illustrated in FIG. 7. Such a server device 700 may include a processor 701 coupled to volatile memory 702 and a large capacity nonvolatile memory, such as a disk drive 703. The server device 700 may also include a floppy disc drive, USB, etc. coupled to the processor 701. The server device 700 may also include network access ports 706 coupled to the processor 701 for establishing data connections with a network connection circuit 704 and a communication network 707 (e.g., an Internet protocol (IP) network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method for providing an immersive contextual audio effects for an eBook, including: generating a generative artificial intelligence model (LXM) prompt based on context and narrative elements of a section of the eBook; applying the generated LXM prompt to a local or remote LXM to receive an LXM response; determining context-appropriate sounds for a subsection of the eBook on which a reader is currently focused based on the received LXM response; and outputting the determined context-appropriate sounds on a sound-producing component.

Example 2. The method of example 1, in which generating the LXM prompt is further based on the section of the eBook, user profile information, and context information.

Example 3. The method of either of examples 1 or 2, in which determining context-appropriate sounds for the subsection of the eBook on which a reader is currently focused based on the received LXM response includes using a sound-generating AI model to generate sounds that match the narrative elements of the subsection of the eBook on which the reader is currently focused.

Example 4. The method of any of examples 1-3, in which determining context-appropriate sounds for the subsection of the eBook on which a reader is currently focused based on the received LXM response includes determining context-appropriate sounds for the subsection of the eBook on which a reader is currently focused using a sound-generating artificial intelligence (AI) model to generate sounds that includes determining the context-appropriate sounds based on character analysis information included in the received LXM response, in which the character analysis information characterizes at least one of an age, gender, or personality of a character in the subsection of the eBook on which the reader is currently focused.

Example 5. The method of any of examples 1-4, further including determining the subsection of the eBook on which the reader is focused using at least one or more of an eye-tracking sensor or a gaze-tracking sensor.

Example 6. The method of example 5, further including adjusting the context-appropriate sounds in response to determining that the reader is focused on a dialogue-focused passage identified in the received LXM response.

Example 7. The method of any of examples 1-6, further including determining the subsection of the eBook on which the reader is currently focused using historical data to determine a reading pace, time estimates for sound effects, and transition points in a soundscape based on the determined reading pace.

Example 8. The method of any of examples 1-7, further including determining music for one or more subsections in the section of the eBook based on the received LXM response.

Example 9. The method of example 8, further including reducing or halting the music during an intense dialogue or transition sounds to match narrative shifts identified in the received LXM response.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A number of different types of memories and memory technologies are available or contemplated in the future, any or all of which may be included and used in systems and computing devices that implement various embodiments. Such memory technologies/types may include non-volatile random-access memories (NVRAM) such as Magnetoresistive RAM (M-RAM), resistive random access memory (ReRAM or RRAM), phase-change random-access memory (PC-RAM, PRAM or PCM), ferroelectric RAM (F-RAM), spin-transfer torque magnetoresistive random-access memory (STT-MRAM), and three-dimensional cross point (3D-XPOINT) memory. Such memory technologies/types may also include non-volatile or read-only memory (ROM) technologies, such as programmable read-only memory (PROM), field programmable read-only memory (FPROM), one-time programmable non-volatile memory (OTP NVM). Such memory technologies/types may further include volatile random-access memory (RAM) technologies, such as dynamic random-access memory (DRAM), double data rate (DDR) synchronous dynamic random-access memory (DDR SDRAM), static random-access memory (SRAM), and pseudostatic random-access memory (PSRAM). Systems and computing devices that implement various embodiments may also include or use electronic (solid-state) non-volatile computer storage mediums, such as FLASH memory. Each of the above-mentioned memory technologies include, for example, elements suitable for storing instructions, programs, control signals, and/or data for use in a computing device, system on chip (SOC) or another electronic component. Any references to terminology and/or technical details related to an individual type of memory, interface, standard or memory technology are for illustrative purposes only, and not intended to limit the scope of the claims to a particular memory system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store target program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A computing device, comprising:
a memory;
a display configured to display an electronic book (eBook);
a sound-producing component; and
at least one processor coupled to the memory, the display and the sound-producing component, and configured to:
generate a generative artificial intelligence model (LXM) prompt based on context and narrative elements of a section of an eBook;
apply the generated LXM prompt to a local or remote LXM to receive an LXM response;
determine context-appropriate sounds for a subsection of the eBook on which a reader is currently focused based on the received LXM response; and
output the determined context-appropriate sounds on the sound-producing component.

2. The computing device of claim 1, wherein the at least one processor is configured to generate the LXM prompt based on the section of the eBook, user profile information, and context information.

3. The computing device of claim 1, wherein the at least one processor is configured to determine the context-appropriate sounds for the subsection of the eBook on which the reader is currently focused based on the received LXM response by using a sound-generating artificial intelligence (AI) model to generate sounds that match the narrative elements of the subsection of the eBook on which the reader is currently focused.

4. The computing device of claim 1, wherein the at least one processor is configured to determine context-appropriate sounds for the subsection of the eBook on which the reader is currently focused based on the received LXM response by determining the context-appropriate sounds based on character analysis information included in the received LXM response, wherein the character analysis information characterizes at least one of an age, gender, or personality of a character in the subsection of the eBook on which the reader is currently focused.

5. The computing device of claim 1, further comprising an eye-tracking sensor or a gaze-tracking sensor, wherein the at least one processor is configured to determine the subsection of the eBook on which the reader is focused by using at least one or more of the eye-tracking sensor or the gaze-tracking sensor.

6. The computing device of claim 4, wherein the at least one processor is further configured to adjust the context-appropriate sounds in response to determining that the reader is focused on a dialogue-focused passage identified in the received LXM response.

7. The computing device of claim 1, wherein the at least one processor is configured to determine the subsection of the eBook on which the reader is currently focused by using historical data to determine a reading pace, time estimates for sound effects, and transition points in a soundscape based on the determined reading pace.

8. The computing device of claim 1, wherein the at least one processor is further configured to determine music for one or more subsections in the section of the eBook based on the received LXM response.

9. The computing device of claim 8, wherein the at least one processor is further configured to reduce or halt the music during an intense dialogue or transition sounds to match narrative shifts identified in the received LXM response.

10. A method for providing an immersive contextual audio effects for an electronic book (eBook), comprising:
generating a generative artificial intelligence model (LXM) prompt based on context and narrative elements of a section of the eBook;
applying the generated LXM prompt to a local or remote LXM to receive an LXM response;
determining context-appropriate sounds for a subsection of the eBook on which a reader is currently focused based on the received LXM response; and
outputting the determined context-appropriate sounds on a sound-producing component.

11. The method of claim 10, wherein generating the LXM prompt is further based on the section of the eBook, user profile information, and context information.

12. The method of claim 10, wherein determining context-appropriate sounds for the subsection of the eBook on which a reader is currently focused based on the received LXM response comprises using a sound-generating artificial intelligence (AI) model to generate sounds that match the narrative elements of the subsection of the eBook on which the reader is currently focused.

13. The method of claim 10, wherein determining context-appropriate sounds for the subsection of the eBook on which a reader is currently focused based on the received LXM response comprises determining context-appropriate sounds for the subsection of the eBook on which a reader is currently focused using a sound-generating artificial intelligence (AI) model to generate sounds that comprises determining the context-appropriate sounds based on character analysis information included in the received LXM response, wherein the character analysis information characterizes at least one of an age, gender, or personality of a character in the subsection of the eBook on which the reader is currently focused.

14. The method of claim 10, further comprising determining the subsection of the eBook on which the reader is focused using at least one or more of an eye-tracking sensor or a gaze-tracking sensor.

15. The method of claim 14, further comprising adjusting the context-appropriate sounds in response to determining that the reader is focused on a dialogue-focused passage identified in the received LXM response.

16. The method of claim 10, further comprising determining the subsection of the eBook on which the reader is currently focused using historical data to determine a reading pace, time estimates for sound effects, and transition points in a soundscape based on the determined reading pace.

17. The method of claim 10, further comprising determining music for one or more subsections in the section of the eBook based on the received LXM response.

18. The method of claim 17, further comprising reducing or halting the music during an intense dialogue or transition sounds to match narrative shifts identified in the received LXM response.

19. A computing device, comprising:
means for generating a generative artificial intelligence model (LXM) prompt based on context and narrative elements of a section of the eBook;
means for applying the generated LXM prompt to a local or remote LXM to receive an LXM response;
means for determining context-appropriate sounds for a subsection of the eBook on which a reader is currently focused based on the received LXM response; and
means for outputting the determined context-appropriate sounds on a sound-producing component.

20. The computing device of claim 19, wherein means for determining context-appropriate sounds for the subsection of the eBook on which a reader is currently focused based on the received LXM response comprises means for using a sound-generating artificial intelligence (AI) model to generate sounds that match the narrative elements of the subsection of the eBook on which the reader is currently focused.
